(19) United States
(12) Patent Application Publication
(10) Pub. No.: US 2006/0138259 A1
(43) Pub. Date: Jun. 29, 2006

(54) Method and device for cracking disk-like or plate-like production parts

(76) Inventor: Horst Wisniewski, Aalen (DE)

Correspondence Address: WOLF GREENFIELD & SACKS, PC;FEDERAL RESERVE PLAZA, 600 ATLANTIC AVENUE, BOSTON, MA, 02210-2206, US

(21) Appl. No.: 10/542,259

(22) PCT Filed: Jan. 14, 2004
(86) PCT No.: PCT/EP04/00207

§ 371 Date: Dec. 30, 2005

(30) Foreign Application Priority Data
Feb. 4, 2003 (EP) 03002405.3

(51) Int. Cl. B02C 11/06

(52) U.S. Cl. 241/31

(57) ABSTRACT

The aim of the invention is to provide a novel machining method, which is particularly suited for cracking disk-shaped or plate-shaped production parts, and to provide a device suited for carrying out this method. To this end, the invention provides that the respective production part is chucked on both sides of the rupture plane between chuck jaw pairs. Afterwards, the chuck jaw pairs are displaced relative to one another by the action of force so that the production part, along the rupture plane, is subjected to a tensile stress alternately on the upper side and underside.

The present invention relates to a method for fracture-splitting disk-like or plate-like production parts, and a device for the performance of the method.

The method for separating production parts produced in one-piece by means of so-called “fracture-splitting” in a predefined plane and in this way avoiding complicated machining work has been known for a long time.

In the main, up to now machining by fracture-splitting has only been used for production parts in which for design reasons a bore was provided in the production part through the inside area of which an essentially radially externally directed fracture-splitting force could be introduced. Examples of this type of machining include the cracking of connecting rods and bearing blocks (see, for example, U.S. Pat. No. 4,569,109) or the cracking of sleeves or rings (see, for example, U.S. Pat. No. 1,440,559).

Where deformation of the production part during the fracture-splitting process could be tolerated, the fracture-splitting force was also introduced into the production parts by means of splitting tools (see DE 27 23 928 or U.S. Pat. No. 3,845,895).

In cases in which the production parts comprised very brittle material, in individual cases compression methods were also used for the fracture-splitting (see, for example, DE-OS 31 36 247).

It is the object of the present invention to provide a completely new machining method which is in particular suitable for the fracture-splitting of disk-like or plate-like production parts and a device suitable therefor to enable splinter-free cracking even with complicated production part shapes.

According to the invention, this object is achieved with regard to the method by the fact that the production part in question is clamped on both sides of the fracture plane between clamping jaw pairs and the clamping jaw pairs are moved towards each other under force so that the production part along the fracture plane is exposed to tensile stress alternately on the upper side and the lower side.

The object is also achieved with a device for the performance of the method, which is equipped with the features of claim 22 or alternatively with the features of claim 23.

The invention is based on the idea of damaging the material in the fracture area not—as in the overwhelming majority of the known methods—in an abrupt way, but to allow the forces required for this to act on the decisive areas of the production part in the form of alternating stress. To put it simply: the material's structure is not to be abruptly destroyed, but slowly ‘worn down’ by an alternating load in the decisive area.

The alternating load in the decisive area of the production part and the associated tensile stress on the upper or underside of the production parts can be generated in a wide variety of ways. A particularly simple procedure consists in the fact that the clamping jaw pairs are induced to take on a periodically changing rocking motion.

In order to increase the influence of the alternating load on the decisive areas of the production part, it can be expedient to superimpose the periodically changing rocking motion of the clamping jaw pairs towards each other with a tensile force which pulls the jaw pairs apart substantially perpendicular to the fracture plane.

Particularly effective machining of the material in the above sense is achieved by the fact that the flexural fatigue stress caused by the periodically changing rocking motion of the clamping jaw pairs in the area of the fracture plane of the production part is introduced in a continuously increasing way.

Here it is also particularly expedient to introduce the flexural fatigue stress generated in a pulsating way.

In the event of superimposition by means of a tensile force, it is advantageous for the tensile force to be continuously increased. If required, the tensile force can also be advantageously introduced in a pulsating way.

Tests have revealed that it is expedient to set the frequency of the periodically changing rocking motion of the clamping jaw pairs in a range between 0.1 and 10 Hz.

In principle, it is possible to generate the forces for the rocking motion of the clamping jaw pairs and the tensile force in any way desired. However, an advantageous embodiment is obtained if the force for inducing the motion and/or the tensile force is generated by hydraulic means.

The movement of the jaw pairs towards each other can be achieved in a wide variety of ways. For example, both jaw pairs can be moved—in relation to an immovable base. However, it is also possible to arrange one jaw pair immovably on the base and to move the other jaw pair.

During machining by fracture-splitting, it is known and customary to assist the fracture-splitting process by providing a fracture notch and also to influence its location and direction. In connection with the method according to the invention, it is, therefore, expedient, to provide the production part with a fracture notch of this kind on its upper side and/or underside in the area of the fracture plane.

Depending upon the field of application and the production part configuration, it may be expedient to give the fracture notch a specific shape. For example, in the case of disk-like production parts it may be advantageous for the fracture notch to enclose an angle in relation to the radius. An arrangement of this kind is particularly suitable for the fracture-splitting of brake disks for which the method according to the invention is particularly suitable.

It is advantageous for this angle to be between 5° and 30°. In the case of disk-like production parts in the form of brake disks, it is expedient for the fracture notch on the upper side to be arranged offset in relation to the fracture notch on the underside of the disk.

Good, splinter-free fracture results are always achieved if the clamping jaw pairs are arranged in such a way that their free ends extend from opposite sides as far as the fracture plane.

It can be expedient for certain production part configurations for the fracture notches to be created by cutting edges which are arranged in the area of the free ends of jaws of one of the two jaw pairs, i.e. integrated therein.

In the event that there is a requirement to crack disk-like production parts whose fracture plane is to enclose an angle relative to the radius of the production part, it is advantageous for the cutting edges provided for notching also to enclose an angle relative to the radius of the disk-like production part. In this case, it is again advantageous to select an angle between 5° and 30°.

As explained above, the movement of the jaw pairs towards each other can be achieved in a wide variety of ways. For example, a suitable device for the performance of the method, which is equipped with a base, can be equipped either according to claim 22 with two jaw pairs mounted movably on the base or according to claim 23 with one immovable and one movable jaw pair arranged on the base. With both variants, however, according to the invention, a drive is provided which acts in each case on the movable jaw pairs and moves them to and fro periodically. In addition, with both variants, according to the invention a control unit is provided with which the frequency and force of the to-and-from movement of the mobile jaw pair may be adjusted in each case.

In principle, the drive for the movably arranged jaw pairs can be equipped in any way. However, it is particularly advantageous for the drive to comprise a hydraulic unit with at least one pump, at least one valve arrangement and at least one actuator cylinder, which acts on one or both of the jaw pairs.

Advantageously, the valve arrangement can comprise a hydraulic proportional, servo or control valve. It is also expedient for the valve arrangement to have a controllable pressure-reducing valve.

For further explanation and understanding, the following is a more detailed description and explanation of an example of an embodiment of a device according to the invention for the performance of the method according to the invention.

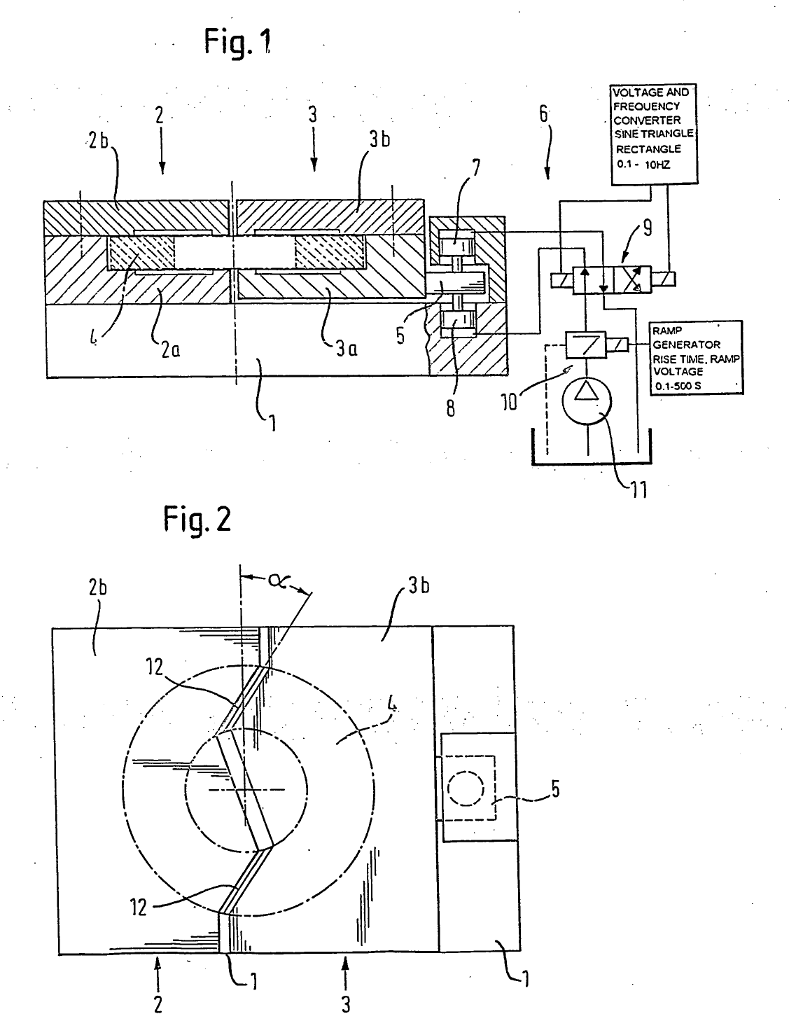

FIG. 1 is a schematic side view of the device according to the invention with a drive and a wiring diagram for a hydraulic unit connected to the drive, and

FIG. 2 is an overview of the device according to FIG. 1, but without the wiring diagram.

FIGS. 1 and 2 show a variant of the device in which an immovable jaw pair 2 and a movable jaw pair 3 are mounted on a base 1.

The mounted jaw pair 2 mounted immovably on the base 1 comprises a lower jaw 2a and an upper jaw 2b.

The jaw pair 3 mounted movably on the base has a similar design and also comprises a lower jaw 3a and an upper jaw 3b.

The upper jaw 2b and the upper jaw 3b can be lifted off the respective lower jaw 2a or 3a so that a production part 4 may be inserted between the jaws.

In this case, the production part is a brake disc, which is to be separated into two parts by fracture-splitting.

After the insertion of the production part 4, the upper jaw 2b or 3b can be firmly connected to its respective lower jaw 2a or 3a in the conventional way and in this way the production part 4 can be firmly clamped between the jaws.

In this example of an embodiment, the lower jaw 3a of the movable jaw pair 3 is connected to a drive 6 by means of a lever arm 5.

As shown schematically in FIG. 1, the drive 6 has two hydraulic cylinders 7 and 8 firmly connected to the base, whereby the hydraulic cylinder 7 acts with its piston rod on the upper side of the lever arm 5 and the hydraulic cylinder 8 acts with its piston rod on the underside thereof.

As also shown in FIG. 1, the hydraulic cylinders 7 and 8 are embodied as cylinders with a single action. Obviously, it is also possible to use one hydraulic cylinder with a double action instead of two hydraulic cylinders with a single action. The essential thing is that an arrangement is selected in which the lever arm 5 can be moved up and down periodically.

In the example of an embodiment shown in FIG. 1, the cylinder chambers of the hydraulic cylinders 7 and 8 with a single action are connected by lines to a valve 9. This valve can be designed as a proportional, servo or control valve. The only essential thing is that the hydraulic cylinders 7 and 8 are alternately exposed to hydraulic fluid, i.e. that the lever arm 5 executes a pulsating upward and downward movement.

The valve 9 is connected to a controllable pressure-reducing valve 10, which is in turn fed by a hydraulic pump 11.

The pressure-reducing valve 10 is in turn controlled by a so-called ramp generator with which the rise time for the pressure-reducing valve 10 can be set in accordance with the cracking conditions in question.

The above-described drive 6 for the lever arm 5 can also have a different design. The only essential thing is that the lever arm 5 can be moved up and down with a suitable force and prespecified frequency. As already described, if necessary, the forces introduced can also be increasing or pulsating.

Another cylinder (not shown) with a horizontal direction of action can also engage with the lever arm 5 and in this way the rocking motion created by the hydraulic cylinders 7 and 8 can be superimposed by a tensile force, which pulls the jaw pairs apart substantially perpendicular to the fracture plane.

As FIG. 2 shows, in this example of an embodiment, the production part 4 in the form of a brake disc is not to be cracked radially. Instead, the prespecified fracture plane should be inclined at an angle a to the radius.

To achieve a crack of this kind, as shown in FIG. 2, in the areas of the front sides facing each other, the jaws in the clamping jaw pairs 2 and 3 are also inclined at an angle a towards each other.

In this example of an embodiment, the production part 4 is provided with a fracture notch on both its upper side and its underside in the area of the fracture plane—this is indicated schematically in FIG. 2 as a line arranged between the front edges of the clamping jaws facing each other.

1. Method for cracking disk-like or plate-like production parts along a prespecified fracture plane, whereby the respective production part is clamped on both sides of the fracture plane between clamping jaw pairs and the clamping jaw pairs are moved towards each other under the action of force in such a way that the production part along the fracture plane is subjected to a tensile stress alternately on the upper side and underside.

2. Method according to claim 1, wherein the tensile stress is generated by a periodically changing rocking motion of the clamping jaw pairs towards each other.

3. Method according to claim 2, wherein the periodically changing rocking motion of the clamping jaw pairs is superimposed by a tensile force which pulls the jaw pairs apart essentially perpendicular to the fracture plane.

4. Method according to claim 2, wherein the flexural fatigue stress generated by the periodically changing rocking motion of the clamping jaw pairs in the area of the fracture plane of the production part is introduced in a continuously increasing way.

5. Method according to claim 2, wherein the flexural fatigue stress generated by the periodically changing rocking motion of the clamping jaw pairs in the area of the fracture plane of the production part is introduced in a pulsating way.

6. Method according to claim 3, wherein the tensile force is continuously increased.

7. Method according to claim 3, wherein the tensile force is introduced in a pulsating way.

8. Method according to claim 1, wherein the frequency of the motion is between 0.1 and 10 Hz.

9. Method according to claim 7, wherein the frequency of the tensile force is between 0.1 and 10 Hz.

10. Method according to claim 1, wherein the force for the motion is generated hydraulically.

11. Method according to claim 3, wherein the tensile force is generated hydraulically.

12. Method according to claim 1, wherein, to generate the motion relative to an immovable base, both jaw pairs are moved towards each other.

13. Method according to claim 1, wherein, to generate the motion relative to an immovable base, one jaw pair is immovable and the other jaw pair is moved.

14. Method according to claim 1, wherein the production part is provided with a fracture notch on the upper side and/or the underside in the area of the fracture plane.

15. Method according to claim 14 for cracking a disk-like production part, wherein the fracture notch encloses an angle relative to the radius.

16. Method according to claim 15, wherein the angle is between 5° and 30°.

17. Method according to claim 14, wherein the fracture notch on the upper side of the production part is offset relative to the fracture notch on the underside.

18. Method according to claim 1, wherein the free ends of the clamping jaw pairs extend from opposite sides to as far as the fracture plane.

19. Method according to claim 18, wherein the fracture notches are created by cutting edges, which are arranged in the area of the free ends of the jaws of one of the two jaw pairs.

20. Method according to claim 19 for cracking a disk-like production part, wherein the cutting edges enclose an angle relative to the radius of the disk-like production part.

21. Method according to claim 20, wherein the angle is between 5° and 30°.

22. Device for performing the method according to claim 1,
with a bases,
a first jaw pair movably-mounted on the base,
a second jaw pair movably-mounted on the base,
a drive, with which the movably-mounted jaw pairs can be moved periodically to and fro, and
a control unit with which the frequency and force of the to and fro movement of the two jaw pairs can be adjusted.

23. Device for performing the method according to claim 1,
with a base,
a first jaw pair immovably-mounted on the base,
a second jaw pair movably-mounted on the base,
a drive, with which the movably-mounted second jaw pair can be moved periodically to and fro, and
a control unit with which the frequency and force of the to and fro movement of the second jaw pair can be adjusted.

24. Device according to claim 22, wherein the drive comprises a hydraulic unit with at least one pump, at least one valve arrangement and at least one actuator cylinder, which act on one or both jaw pairs.

25. Device according to claim 24, wherein the valve arrangement comprises a hydraulic proportional, servo or control valve.

26. Device according to claim 24, wherein the valve arrangement comprises a controllable pressure-reducing valve.
